(19) United States
(12) Patent Application Publication
(10) Pub. No.: US 2021/0267138 A1
(43) Pub. Date: Sep. 2, 2021

(54) SYSTEM AND APPARATUS FOR CROP MANAGEMENT

(71) Applicants: Joseph W. Boudeman, Pacifica, CA (US); Joseph James Boudeman, Pacifica, CA (US)

(72) Inventors: Joseph W. Boudeman, Pacifica, CA (US); Joseph James Boudeman, Pacifica, CA (US)

(21) Appl. No.: 17/259,396

(22) PCT Filed: Jul. 10, 2019
(86) PCT No.: PCT/US2019/041268

§ 371 Date: Jan. 11, 2021

Related U.S. Application Data
(60) Provisional application No. 62/696,085, filed on Jul. 10, 2018.
(60) Provisional application No. 62/752,259, filed on Oct. 29, 2018.

(51) Int. Cl. A01G 9/24; A01G 7/00

(52) U.S. Cl. CPC A01G 9/243; H02S 20/30; A01G 7/00

(57) ABSTRACT

A crop management system comprising a crop management unit adapted and configured to sense environmental conditions and/or conditions of surrounding agricultural features and interact with such surrounding agricultural features. The crop management system can perform such functions as spraying, misting, dusting, seeding/planting, irrigation, vacuuming, trimming, harvesting, tilling, weeding, pollinating, aerating, pruning and/or any other known and/or convenient crop management function(s). Additionally, the crop management system can comprise an energy harvesting structure adapted and configured to harvest energy from the environment and, in some embodiments, delivery the energy to the crop management system.

### CROSS-REFERENCE TO RELATED APPLICATIONS

The present application claims the benefit of priority to prior-filed and co-pending U.S. Provisional Patent Application No. 62/696,085, filed Jul. 10, 2018 and U.S. Provisional Patent Application No. 62/752,259, filed Oct. 29, 2018, the entireties of each of which are hereby incorporated herein by reference.

### BACKGROUND

### Technical Field

The present device relates to the field of “green technology” particularly agricultural crop and energy harvesting systems for increased agricultural production and energy conservation.

### Background

The food generation process through agriculture is often complicated, time consuming and results in a lot of waste of resources. Insufficient or inefficient utilization of water, energy, and nutrients result in poor growth and agricultural waste. Energy harvesting structures have been developed, but the cost of producing the structures and their use is not well balanced as the cost of producing harvesting structures can be more than the savings of utilization.

What is needed is a crop management system equipped with efficient and energy saving devices adapted and configured to increase crop production and decrease agricultural or other waste.

### BRIEF DESCRIPTION OF THE DRAWINGS

Further details of the present device are explained with the help of the attached drawings in which:

FIG. 1 depicts a perspective view of the present device in an open field or other area.

FIG. 2 depicts a planar view of the frame unit, an energy harvesting unit, and a support member operated remotely.

FIG. 3a depicts a perspective view of the present device to illustrate movement of the frame unit away from the energy harvesting unit.

FIG. 3b depicts a perspective view of the present device to illustrate movement of the frame unit towards the energy harvesting unit.

FIG. 4a depicts a perspective view of the present device to illustrate its use.

FIG. 4b depicts a perspective view of the present device to illustrate vertical and horizontal movement of the frame unit and the support member.

FIG. 5 depicts an embodiment of the crop management unit.

FIG. 6 depicts an alternate embodiment of a crop management unit.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

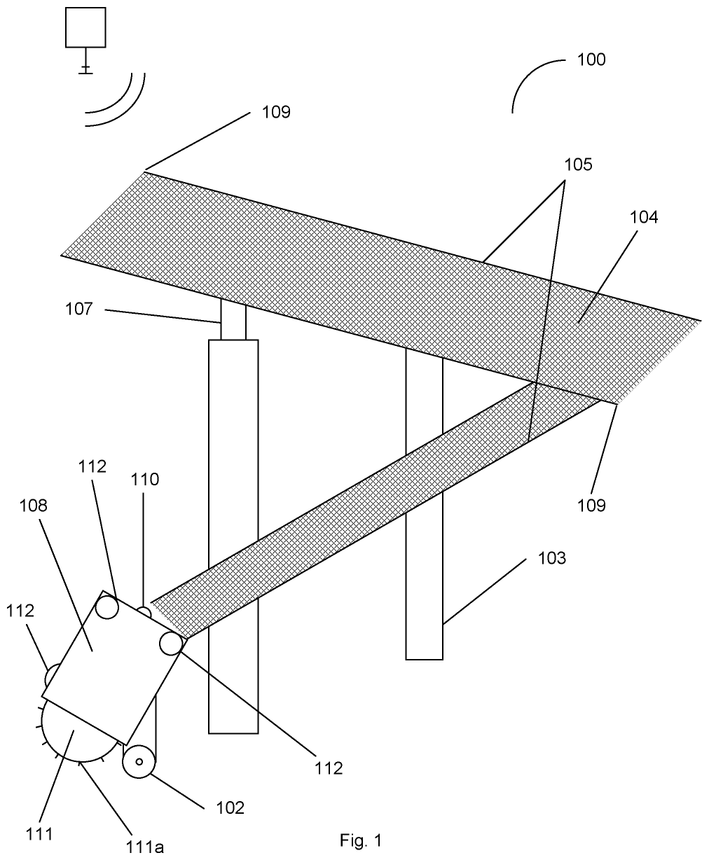

FIG. 1 depicts a crop management unit 108 comprising systems and apparatuses 111 to attend to various known, convenient and/or desired crop management functions such as spraying, misting, dusting, seeding/planting, irrigation, vacuuming, trimming, harvesting, tilling, weeding, pollinating, aerating, pruning and/or any other known and/or convenient crop management function(s). In the embodiment depicted in FIG. 1, the systems and apparatuses 111 to attend to crop management functions can be in the form of a multi-function delivery system comprising multiple nozzles and/or devices 111a adapted and/or configured to perform customized functions and/or operations. In the embodiment depicted in FIG. 1, the systems and apparatuses 111 to attend to crop management functions, can be in the form of a circular device comprising various nozzles and/or devices 111a wherein each of the nozzles and/or devices 111a can be adapted and/or configured to perform at least one specific function and/or operation and the systems and apparatuses 111 can rotate such that the desired nozzle and/or device 111a to be used is exposed. Additionally, in some embodiments one or more of the various nozzles and/or devices 111a can selectively cooperate with one or more storage containers 120 which can contain any known, convenient and/or desired substances, such as seeds, fertilizer, water. In some embodiments the storage containers 120 can be internal to the structure of the crop management unit 108. However, in alternate embodiments, the storage containers 120 can be external to the primary structure of the crop management unit 108. In operation, the various nozzles and/or devices 111a can cooperate with both the surrounding environment, such as agriculture, structures and/or soil, and/or the storage containers 120.

Accordingly, the crop management unit 108 can perform one or more of the following functions: spraying, misting, seeding/planting, dusting, irrigation, vacuuming, trimming, harvesting, tilling, weeding, pollinating, aerating, pruning and/or any other known and/or convenient crop management function(s).

In some embodiments the crop management unit 108 can have any known, convenient and/or desired exterior dimensions, geometry and/or appearance. In some embodiments, the crop management unit 108 can comprise one or more holding units 110 such as a hook, for holding additional structure(s) to with the crop management unit 108 such as, but not limited to, a frame unit 105, an energy harvesting unit 104, a support member 103, a vacuum, a hose, an auger, drag line of conveyor, a conveyor belt, a device to spray a liquid, a device to mist the crop, a device to harvest the crop and/or any other known, convenient and/or desired agriculture related apparatus.

In alternate embodiments, the crop management unit 108 can comprise one or more wheels 102, enabling movement of the crop management unit 108 from one location to another location, either via self-propulsion and/or by being moved by an external force/device. In some embodiments, the crop management unit 108 can be coupled with a movable vehicle or a movable structure. In some alternate embodiments, the crop management unit 108 can be attached to a stationary structure to hold the unit 108 substantially stationary. The crop management unit 108 can be managed manually, automatically, semi-automatically, and/or by any known, convenient and/or desired external or internal mechanism, machine and/or force.

As depicted in FIG. 1, crop management unit 108 can selectively cooperate with one or more frame units 105. In some embodiments, the one or more frame units 105 can comprise a frame structure with a plurality of vertically aligned thin structures in opposite directions forming plurality of hollow elements, the opposite ends of which can be adapted to interlock. In alternate embodiments, the frame structure can be, but not limited to, wire, metal, mesh, polymer, fabric, wood and/or any other known convenient and/or desired material and/or combination of materials. The one or more frame units 105 can be mounted onto one or more support members 103 and can be positioned at a fixed point or move up and down the one or more support members 103 to manage the growth of an agricultural crop or crops.

In some embodiments, the one or more frame units 105 can be positioned in any direction by one or more linear actuating devices 106 and 107 and the one or more support members 103 can support one or more energy harvesting units 104, adapted and configured to derive energy from the environment.

In some embodiments the frame unit(s) 105 can be positioned in any known, convenient and/or desired relation to the support members 103, such as below the energy harvesting unit 104, positioned above the energy harvesting unit, horizontally at a distance from the energy harvesting unit and/or in any other known, convenient and/or desired configuration. The linear actuating devices 106 107 can be positioned by a trolley, a hoist, a winch, a block, a lift, a crane, a skewer, a jack, and/or any other known, convenient and/or desired mechanism and/or machine such that the devices 106 107 can guide/position the movement of the one or more frame units 105 in any desired manner. The linear actuating devices 106 107 can be moved manually, automatically or remotely to a position/optimize the crop growth needs and energy harvesting potential of the system. The one or more frame units 105 can provide support to plants for the plant's or plants' optimized growth. The one or more frame units 105 can also support the plants to receive optimal water as necessary for their growth from air, a well or a water reservoir.

In some embodiments, the one or more frame units 105 can be coupled with the crop management unit 108 such that it can be moved from one location to another or can be held stationary at one position on the ground. Additionally, in some embodiments the crop management unit 108 can be adapted and/or configured to receive power from the one or more frame units 108. The frame unit 105 can be held stationary in one position on the ground by the one or more support members 103. In some embodiments, the one or more support members 105 can be held stationary by inserting a portion of some or all the one or more support members 105 in the ground by a method such as, but not limited to, driven post(s), excavated and covered post(s), screwing, anchoring, drilling, implanting stable attachments inside the ground and attaching the support member to this implant and/or via any other known, convenient and/or desired mechanism.

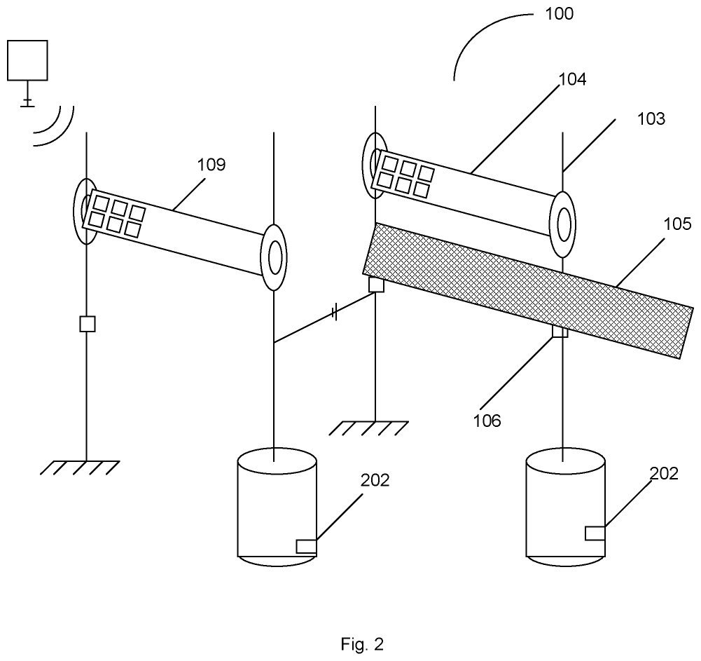

As depicted in FIG. 2, the one or more energy harvesting units 104 can comprise one or more energy harvesting panels such as, by way of non-limiting example, solar energy panels. In some embodiments, the one or more energy harvesting units 104 can be solar energy panels which use a luminescent dye to convert green light, not efficiently used by plants, into beneficial red light—that is, beneficial to plant growth and development. In some embodiments, the one or more energy harvesting units 104 can be solar panels which uses a luminescent dye with dye concentrations such that light removed by the solar energy panel is offset by the increase in usable red light from the dye. In some embodiments, the luminescent dye can be embedded in a layer that is coupled with the solar energy panel and/or the fluorophore and/or luminescent material(s) can comprise perylenes, rhodamines, merocyanines, boranes, caboranes, metallacarboranes and/or any other known, convenient and/or desired materials, compounds and/or elements adapted, configured and/or capable of harvesting energy from the surrounding environment.

In some embodiments, the one or more energy harvesting units 104 can comprise dye synthesized solar cells, luminescent solar collectors and/or concentrators, near-infrared photovoltaics, polymer solar cells, perovskites, quantum dots, organic solar films (such as Heliatek®/Helisol®) and/or any other known, convenient and/or desired device and/or devices adapted and/or configured to capture energy from the environment. In some embodiments, the one or more energy harvesting units 104 can be flexible and can change its direction such that they can face an energy source, including, but limited to, the sun. In alternate embodiments, the one or more energy harvesting units 104 can comprise a substantially planar surface with a first end edge, a second end edge, a first lateral edge and a second lateral edge. In some alternate embodiments, energy harvesting panels can be integrated within the planar surface or mounted onto the planar surface of the one or more energy harvesting units 104 such that the movement of the one or more energy harvesting units 104 correspondingly moves the energy harvesting panels.

In some embodiments, the one or more energy harvesting units 104 can comprise one or more sensors 109 adapted and configured to obtain information regarding the one or more energy harvesting units 104 and/or the environment, such as sun position/intensity, soil, plant(s), and/or any other known, convenient and/or desired items. The sensor(s) 109 can coordinate, guide and manage the movements of plant management system 108. The sensor(s) 109 can be operated/controlled remotely through a computer, through a mobile device, through a web-based application, through a mobile app. The plant management system 108 can be operated remotely via sensor(s) 109 coupled with the energy harvesting unit 104. In some embodiments, each energy harvesting panel can work independently or in coordination with one or more other systems.

In operation, the one or more energy harvesting units 104 can acquire energy from the environment and store the energy in one or more batteries (energy storage devices) 202 within the system and/or the system can be energized and delivery power directly to a crop management unit 108 when the crop management unit 108 is in electrical communication with the energy harvesting units 104. In some embodiments, the crop management unit 108 can selectively electrically couple with the energy harvesting units 104 and/or other component of the crop management system and be periodically charged/recharged. Thus, in some embodiments the crop management unit 108 can operate on battery power and return (autonomously or otherwise) to a designated portion of the system to charge/recharge an on-board battery (energy storage device) of the crop management unit 108.

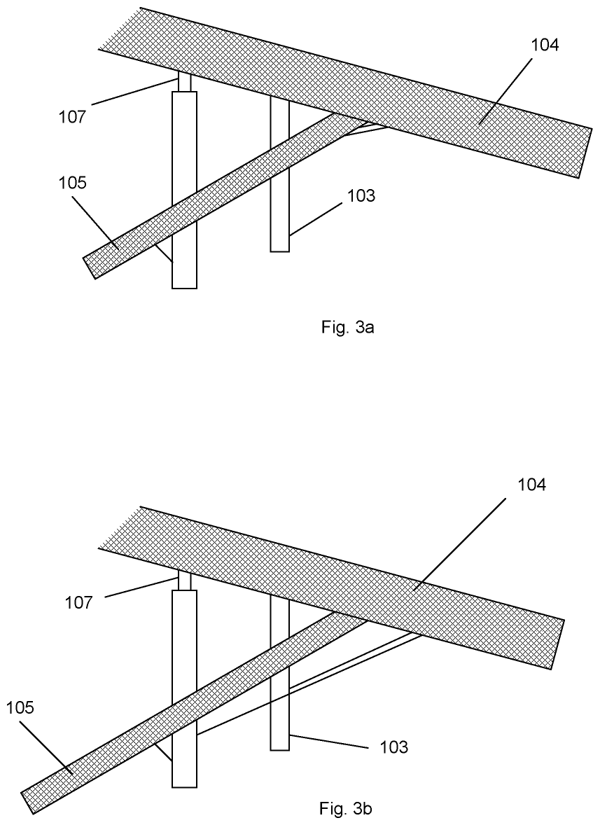

In some embodiments depicted in FIGS. 3a and 3b, the one or more energy harvesting units 104 can be movable and can move toward the frame unit 103 (FIG. 3b) or away from the frame unit 103 (FIG. 3a), can move up, down, right side, left side, or rotationally relative to the one or more support members 103. In some embodiments, the one or more energy harvesting units 104 can be positioned in any geometric configuration by linear actuating devices 106 107. In alternate embodiments, the linear actuating devices 106 107 can be powered/controlled by a trolley, a hoist, a winch, a block, a lift, a crane, a skewer, a jack and/or any other known convenient and/or desired system and/or apparatus adapted and/or configured to control/position and/or power the frame unit 104. The linear actuating devices 106 107 can be moved manually, automatically or remotely to move the frame unit to a position optimizing the crop growth needs or desires and/or energy harvesting potential.

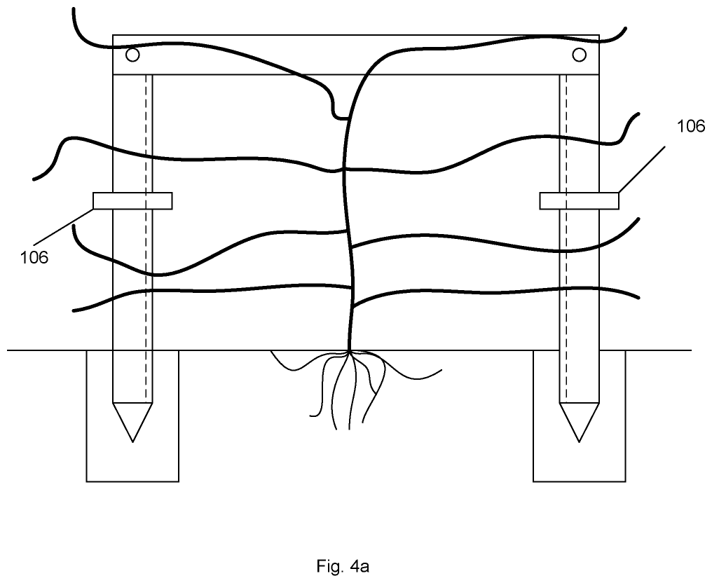

In the embodiment depicted in FIGS. 4a and 4b, one or more support members 103 can be positioned at two opposite sides of a plant by coupling them with the ground. In some embodiments, one or more support members 103 can hold the frame unit 104 in such a configuration that the frame unit provides both horizontal and vertical support for the plant's or plants' growth. If growth of the plant(s) extends beyond desired growth, as depicted in FIG. 4 the frame unit 104 can be moved via an actuation device 114 in a direction/configuration to trim the plant to desired growth to optimize plant growth and harvesting the plant(s).

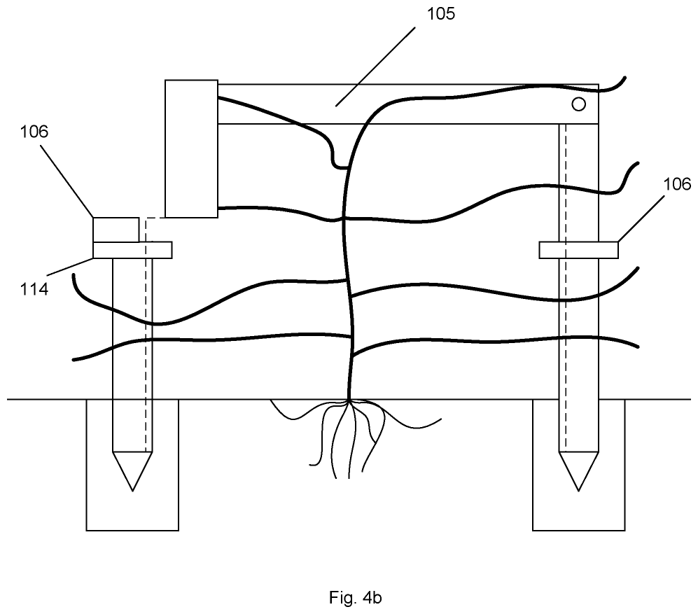

FIG. 5 depicts an embodiment of the crop management unit 108. In the embodiment depicted in FIG. 5, the crop management unit 108 can comprise one or more sensor 112 adapted and configured to collect information regarding the surrounding environment and/or operation of the crop management unit 108, such as soil conditions, plant conditions, plant growth and/or any other known, convenient and/or desired information and/or data. In some embodiments, the crop management unit 108 can comprise a battery (energy storage device) 502 and/or charging port 504 such that the crop management unit 108 can function by using battery power.

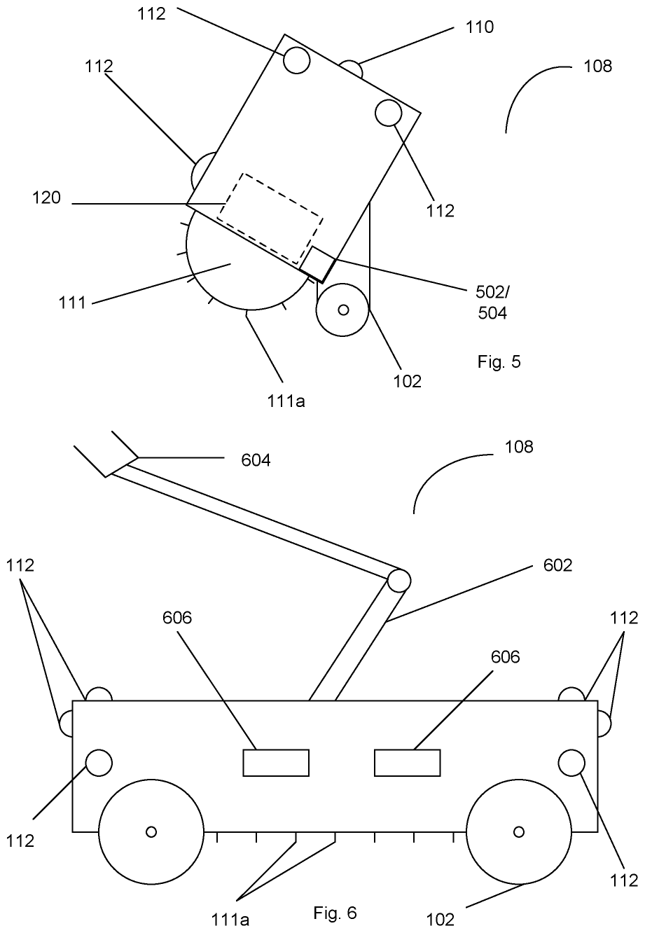

FIG. 6 depicts an alternate embodiment of a crop management unit 108. In the embodiment depicted in FIG. 6, the crop management unit 108 can comprise an adjustable/positionable arm 602 with a gripper portion 604 such that the crop management unit 108 can interact with the surrounding environment and/or plant(s). Additionally, in some embodiments, the crop management unit 108 can further comprise various tools 606, positioned in any known, convenient and/or desired location on the crop management unit 108, to perform any known, convenient and/or desired function and/or interact with the surrounding environment and/or plant(s) in any known, convenient and/or desired manner. In the embodiment depicted in FIG. 6, the crop management unit 108 can comprise a battery (energy storage device) 502 and a charging port 504. Further, in the embodiment depicted in FIG. 6, the crop management unit 108 can comprise various nozzles and/or devices 111a positioned in any known convenient and/or desired location on the crop management unit 108, to perform any known, convenient and/or desired function and/or interact with the surrounding environment and/or plant(s) in any known, convenient and/or desired manner

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed is:

1. A crop management system comprising:
a support member;
an energy harvesting unit coupled with said support member; and
a crop management unit, adapted and configured to cooperate with said support member
and said energy harvesting unit.

2. The crop management system of claim 1 further comprising a frame coupled with said support member and adapted and configured to selectively engage an adjacent plant.

3. The crop management system of claim 2 wherein said energy harvesting unit is independently adjustable relative to said support member.

4. The crop management system of claim 2 wherein said frame is independently adjustable relative to said support member.

5. The crop management system of claim 3 wherein said frame is independently adjustable relative to said support member.

6. The crop management system of claim 1 wherein said energy harvesting unit comprises at least one of dye synthesized solar cells, luminescent solar collectors, luminescent solar concentrators, near-infrared photovoltaics, polymer solar cells, perovskites, quantum dots and organic solar films.

7. The crop management system of claim 6 wherein said energy harvesting unit comprises solar energy panels which use a luminescent dye to convert green light into red light.

8. The crop management system of claim 7 wherein said red light is beneficial red light.

9. The crop management system of claim 1 wherein said energy harvesting unit comprises solar energy panels which use a luminescent dye to convert green light into red light.

10. The crop management system of claim 9 further comprising
a frame coupled with said support member and adapted and configured to selectively engage an adjacent plant;
wherein said energy harvesting unit is independently adjustable relative to said support member; and
wherein said frame is independently adjustable relative to said support member.

11. The crop management system of claim 10 wherein said energy harvesting unit is electrically coupled with said crop management unit.

12. The crop management system of claim 10, wherein said energy harvesting unit is in electrical communication with an energy storage device such that energy harvested by said energy harvesting unit can be transferred to and stored by said energy storage device.

13. The crop management system of claim 12 further comprising a frame coupled with said support member and adapted and configured to selectively engage an adjacent plant.

14. The crop management system of claim 13
wherein said energy harvesting unit is independently adjustable relative to said support member; and
wherein said frame is independently adjustable relative to said support member.

15. The crop management system of claim 12 wherein said crop management unit comprises an onboard energy storage device.

16. The crop management system of claim 15 wherein said energy storage device is in selective electrical communication with said onboard energy storage device such that stored power can be selectively transferred from said energy storage device to said onboard energy storage device.

17. The crop management system of claim 16 further comprising a frame coupled with said support member and adapted and configured to selectively engage an adjacent plant.

18. The crop management system of claim 17 wherein said energy harvesting unit is independently adjustable relative to said support member.

19. The crop management system of claim 17 wherein said frame is independently adjustable relative to said support member.

20. The crop management system of claim 19 wherein said frame is independently adjustable relative to said support member.
